(19) United States
(12) Patent Application Publication
(10) Pub. No.: US 2019/0242571 A1
(43) Pub. Date: Aug. 8, 2019

(54) LIGHT AND FAN ASSEMBLY

(71) Applicant: TTI (MACAO COMMERCIAL OFFSHORE) LIMITED, Macau (MO)

(72) Inventors: J. Porter Whitmire, Greenville, SC (US); Miles R. Moody, Simpsonville, SC (US); J. Luke Jenkins, Anderson, SC (US)

(21) Appl. No.: 16/267,428

(22) Filed: Feb. 5, 2019

Related U.S. Application Data
(60) Provisional application No. 62/627,556, filed on Feb. 7, 2018.

(51) Int. Cl. F21V 33/00; F04D 25/08; F21S 8/04; H02K 7/14

(52) U.S. Cl. CPC F21V 33/0096; H02K 7/14; F21S 8/043; F04D 25/088

(57) ABSTRACT

A light and fan assembly may include a body having a first side configured to be positioned adjacent to a ceiling, a second side opposite the first side, and an internal cavity disposed between the first side and the second side. The light and fan assembly may also include a light unit disposed on the second side of the body. The light unit may have an outer perimeter. At least a portion of the outer perimeter may be spaced apart from the body to define an outlet therebetween. The light and fan assembly may further include a motor positioned within the internal cavity, and a fan positioned within the internal cavity and coupled to the motor. The fan may be operable to draw air into the internal cavity and exhaust the air out of the body through the outlet.

### CROSS-REFERENCE TO RELATED APPLICATION

This application claims the benefit of U.S. Provisional Patent Application No. 62/627,556, filed Feb. 7, 2018. The entire contents of each of this application is hereby incorporated by reference herein.

### BACKGROUND

The present subject matter relates to light fixtures, such as puff lights. More specifically, the present subject matter relates to a light fixture including an integrated fan.

Light assemblies are provided in buildings for adding illumination to retail, office, and/or residential settings. Lighting fixtures may provide energy efficient lighting, and add a decorative look to warmly light commercial and/or residential spaces.

### SUMMARY

In one embodiment, a light and fan assembly may include a body having a first side configured to be positioned adjacent to a ceiling, a second side opposite the first side, and an internal cavity disposed between the first side and the second side. The light and fan assembly may also include a light unit disposed on the second side of the body. The light unit may have an outer perimeter. At least a portion of the outer perimeter may be spaced apart from the body to define an outlet therebetween. The light and fan assembly may further include a motor positioned within the internal cavity, and a fan positioned within the internal cavity and coupled to the motor. The fan may be operable to draw air into the internal cavity and exhaust the air out of the body through the outlet.

In another embodiment, a light and fan assembly may include a body having a first side configured to be positioned adjacent to a ceiling, and a second side positioned opposite the first side. The second side may define an outlet. The body may also have a third side disposed between the first and second sides and defining a first inlet, and a fourth side opposite the third side and defining a second inlet. The body may further have an internal cavity disposed between the first, second, third, and fourth. The internal cavity may be in fluid communication with the first inlet, the second inlet, and the outlet. The light and fan assembly may also include a light unit disposed on the second side of the body. The light and fan assembly may further include an inner housing positioned within the internal cavity. The inner housing may define a central opening. The light and fan assembly may also include a motor positioned within the internal cavity and a fan positioned within the central opening of the inner housing and coupled to the motor. The fan may be operable to draw air into the internal cavity through the first inlet and the second inlet and propel the air out of the body through the outlet.

Other aspects of the subject matter will become apparent by consideration of the detailed description and accompanying drawings.

### BRIEF DESCRIPTION OF THE DRAWINGS

FIG. 1 is a perspective view of a light and fan assembly.

FIG. 2 is a schematic, upper plan view of the light and fan assembly of FIG. 1.

FIG. 3 is a schematic, lower plan view of the light and fan assembly of FIG. 1.

FIG. 4 is a schematic, cross-sectional view of the light and fan assembly of FIG. 1 taken along section line 4-4 of FIG. 2.

FIG. 5 is a perspective view of a fan to be used in the light and fan assembly of FIG. 1.

FIG. 6 is a perspective view of another light and fan assembly.

FIG. 7 is a lower plan view of the light and fan assembly of FIG. 6.

FIG. 8 is an exploded view of the light and fan assembly of FIG. 6.

FIG. 9 is a perspective view of an inner housing of the light and fan assembly of FIG. 6.

FIG. 10 is a cross-sectional view of the inner housing of FIG. 9 taken along section line 10-10 of FIG. 9.

FIG. 11 is a cross-sectional view of the light and fan assembly of FIG. 6 taken along section line 11-11 of FIG. 6.

FIG. 12 is a cross-sectional view of the light and fan assembly of FIG. 6 taken along section line 12-12 of FIG. 6.

FIG. 13 is a perspective view of a fan that may be used in the light and fan assembly of FIG. 6.

### DETAILED DESCRIPTION

Before any embodiments are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present subject matter relates to a light and fan assembly including a light emitter and integrated fan. The fan may be configured to exhaust air over a similar area to which the light emitter illuminates.

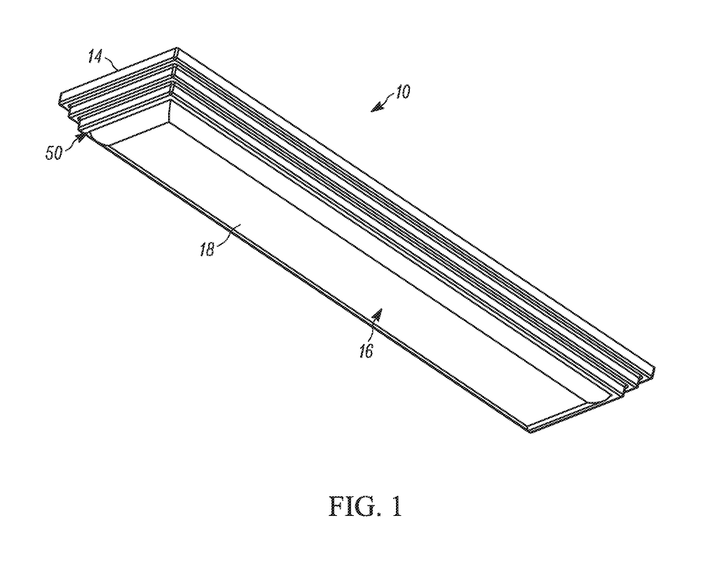

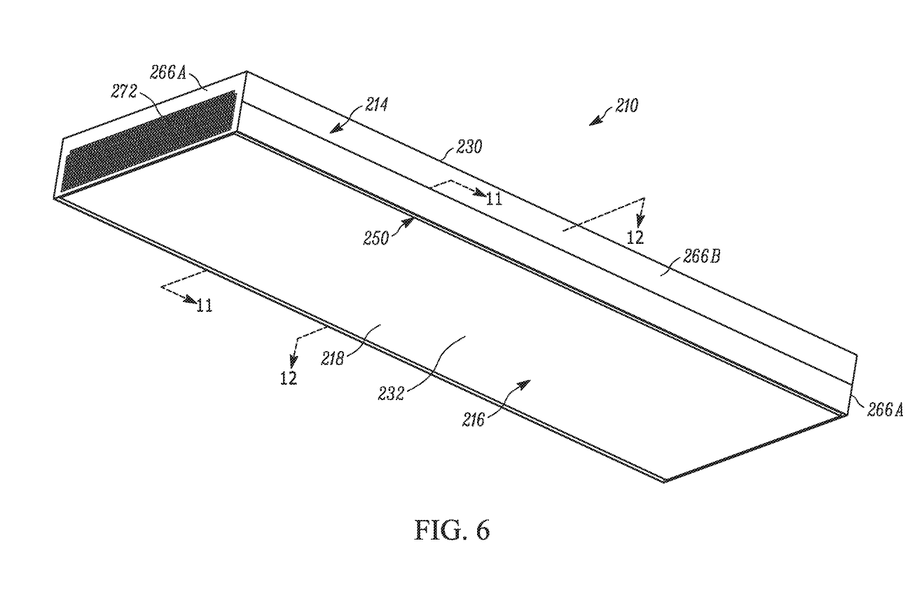

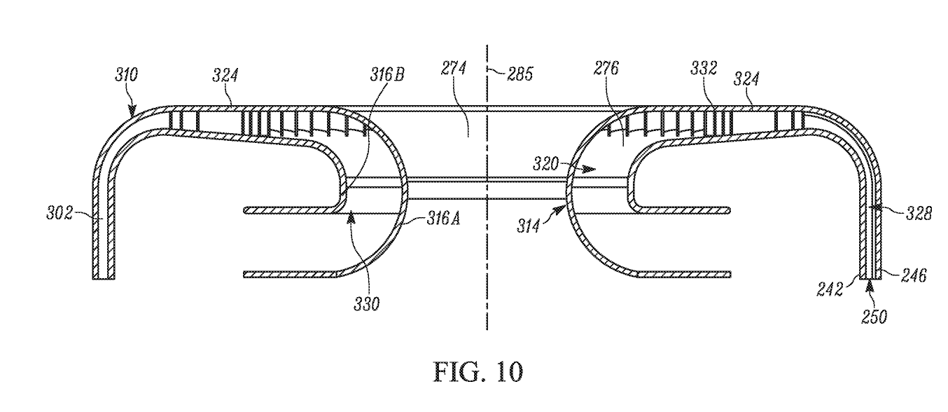

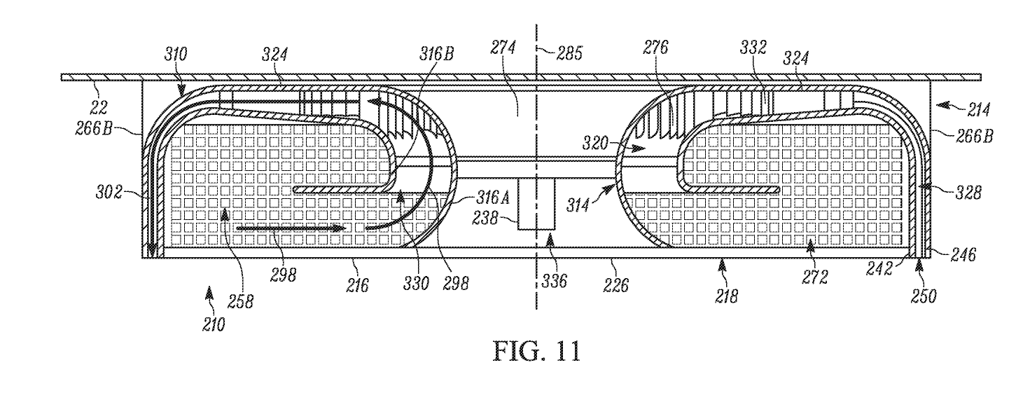

FIGS. 1-5 illustrate a light and fan assembly, generally designated 10. FIGS. 6-13 illustrate a light and fan assembly 210 according to another embodiment. At least some differences and similarities between light and fan assembly 210 and light and fan assembly 10 are described below. Similar features are identified by similar reference numbers, where possible.

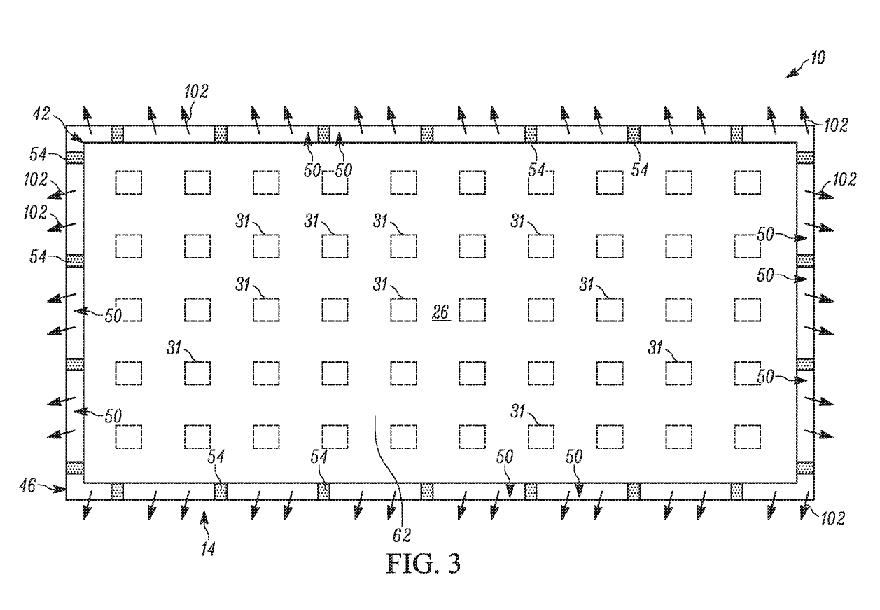

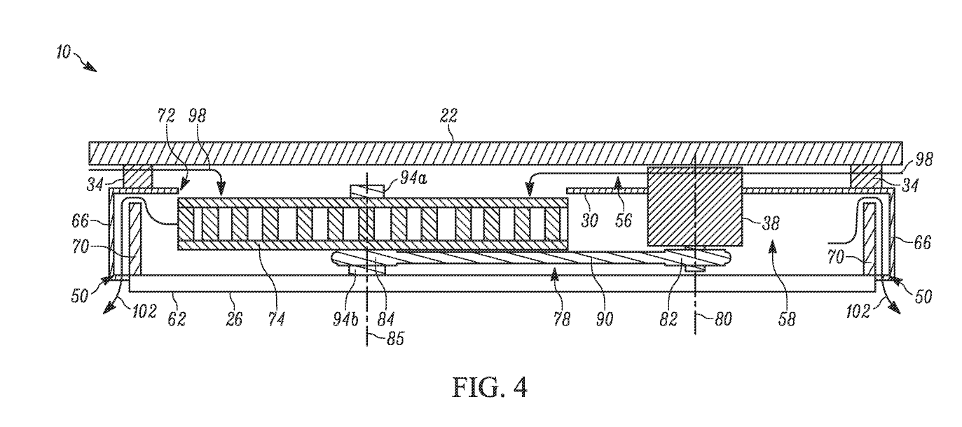

As shown in the illustrated embodiments of FIGS. 1-5, the light and fan assembly 10 may include a body 14 and a light unit 16 that may extend from, be supported by, and/or otherwise be disposed proximate to the body 14. The light unit 16 may include a lens 18 and at least one light emitter 26 (see e.g., FIG. 3) positioned beneath (e.g., between the lens 18 and a surface to which the light and fan assembly attaches 10) and/or covered by the lens 18. In the illustrated embodiment, the light and fan assembly 10 may be referred to as a puff light. The light and fan assembly 10 may be configured to mount or attach (e.g., by way of fasteners, connectors, adhesive, and/or the like) to a ceiling 22 (see e.g., FIG. 4), in some cases. The light emitter 26 may be disposed under or below the lens 18 (e.g., between the lens 18 and the ceiling 22) and be directed away from the ceiling 22, such that the light emitter 26 may provide illumination in a direction away from the ceiling 22, for example, and towards a surface and/or an object (e.g., a floor, a desk, and/or the like) that opposes or faces the ceiling 22 and/or the light and fan assembly 10.

The illustrated body 14 may be rectangular. In some embodiments, the body 14 may have rounded or chamfered corners. In other embodiments, the body 14 may have other desired shapes, such as a square shape, an oblong shape, a circular shape, an oval shape, a hexagonal shape, a cylindrical shape, a symmetrical shape (e.g., relative to a center of the body 14, an asymmetrical shape (e.g., relative to a center of the body 14), and/or the like.

In the illustrated embodiment, an outer boundary of the light unit 16 may define an area less than an area defined by an outer boundary of the body 14. In other words, the area of the lens 18 may be less than the area of the body 14, and a perimeter of the light unit 16 may be less than a perimeter of the body 14, in some cases. The light unit 16 may be positioned on, over, and/or in the body 14 such that the body 14 may extend at least partially around the lens 18 for supporting and/or retaining the lens 18 respective to the body. The lens 18 may have different shapes (e.g., rectangular, circular, etc.) to provide different illumination patterns and/or to match the shape of the body 14. In the illustrated embodiment, the lens 18 may have a concave, or substantially concave shape facing toward the ceiling and a convex, or substantially convex shape facing away from the ceiling. In some embodiments, the lens 18 may include a substantially smooth surface, a textured surface, a curvilinear surface, a curved surface, a linear surface, any combination thereof, and/or the like.

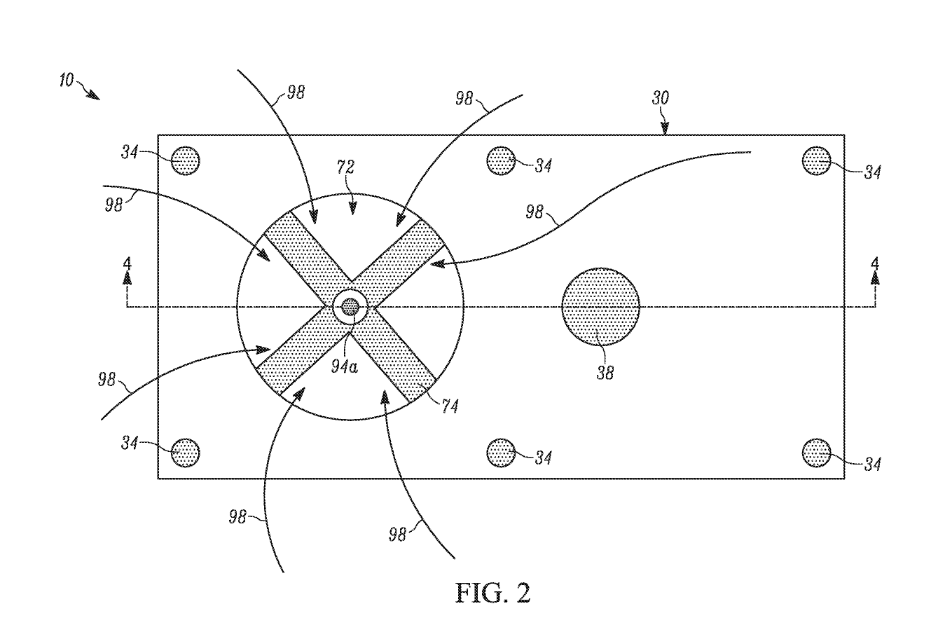

As shown in FIG. 2, the light and fan assembly 10 may include a first, upper side 30. In the illustrated embodiment, the upper side 30 may be substantially flat and/or substantially rectangular in shape. The upper side 30 may include a plurality of posts or spacers 34. The posts 34 may extend away from the upper side 30. The posts 34 may be positioned proximate a periphery of the upper side 30. In the illustrated embodiment, the upper side 30 may include six cylindrically shaped posts 34. Each post 34 may be evenly spaced from any adjacent posts 34. In other embodiments, the upper side 30 may include fewer or more posts 34, and/or the posts 34 may be positioned elsewhere on the upper side 30. The posts 34 may facilitate attachment of the light and fan assembly 10 to a surface (e.g., a ceiling, a wall, and/or the like), in some embodiments.

In some embodiments, the light and fan assembly 10 may also include a motor 38. The motor 38 may also be accessible through the upper side 30. In the illustrated embodiment, the motor may include an alternating current (AC) induction motor 38, which may use electromagnetic induction to generate a torque. In other embodiments, a different type of motor may be used (e.g., a direct current (DC) motor, and/or the like).

FIG. 3 illustrates a second, lower side 62 of the light and fan assembly 10, which is opposite the side and/or view depicted in FIG. 2. As shown in FIG. 3, the light emitter 26 may face away from the upper side 30 (see e.g., FIG. 2) and may be in the form of a panel or plurality of light emitting diodes (LEDs) 31, generally shown in broken lines for illustration purposes only. In some embodiments, the LEDs 31 may be dimmable. In other words, a user may control and/or adjust the intensity of the light emitted by the LEDs 31. In other embodiments, the light emitter 26 may include one or more fluorescent bulbs, incandescent bulbs, LED bulbs, or any other type of light source or luminaire. As schematically depicted in the illustrated embodiment, the light emitter 26 may include a single panel (e.g., comprised of multiple LEDs) that may be substantially flat and/or rectangular in shape. An area or footprint of the light emitter 26 may be substantially similar to the area or footprint of the lens 18 (see e.g., FIG. 1), in some cases.

Still referring to FIG. 3, and in some embodiments, the light unit 16 may extend to and/or be positioned adjacent to an inner periphery 42 of the body 14 (e.g., such that the perimeter of the light unit 16 may be less than a perimeter of the inner periphery 42). The inner periphery 42 of the body 14 may be spaced apart from an outer periphery 46 of the body 14, which defines the outer boundary of the body 14. One or more outlets 50 may be disposed between the inner periphery 42 and the outer periphery 46 of the body 14. The outlets 50 may be configured to expel or exhaust air entering the body 14 of the light and fan assembly 10 as described herein. One or more spacers 54 may extend between the inner periphery 42 and the outer periphery 46 to define an area of each outlet 50. In the illustrated embodiment, the outlets 50 may be generally rectangular in shape. In other embodiments, the outlets 50 may have other shapes and/or sizes (e.g., circular shapes, elliptical shapes, and/or the like).

Referring now to FIG. 4, the light and fan assembly 10 may be configured to couple to the ceiling 22 via the posts 34. In the illustrated embodiment, each post 34 may extend about the same distance away from the upper side 30 such that each post 34 may be configured to couple to the ceiling 22. A gap 56 may exist between the upper side 30 and the ceiling 22 upon coupling the posts 34 of the light and fan assembly 10 to the ceiling 22. The gap 56 may form one or more inlets of the body 14, through which air may enter. The motor 38 may extend a lesser distance from the upper side 30 than the posts 34. Therefore, the motor 38 may not contact the ceiling 22 upon coupling the light and fan assembly 10 to the ceiling 22. The motor 38 may be operable to actuate a fan (see e.g., 74, FIG. 4) for drawing air into the light and fan assembly 10 by way of the gap 56 and/or one or more additional inlets, and expel the air from one or more outlets (see e.g., 50, FIG. 4) for use in cooling, heating, and/or otherwise circulating air in spaces adjacent to the light and fan assembly 10.

In some embodiments, the light and fan assembly 10 may also include an internal cavity 58 defined between the upper side 30, the lower side 62, and one or more side walls 66. The lower side 62 may be positioned opposite the upper side 30 and may support the light unit 16. The side walls 66 may extend substantially orthogonal between the upper side 30 and the lower side 62. One or more exhaust walls 70 may be positioned within the cavity 58 and extend from the lower side 62 substantially parallel to the side walls 66. The exhaust walls 70 may be positioned proximate an edge of the light emitter 26. A space between an exhaust wall 70 and a corresponding side wall 66 may define the one or more outlets 50.

In some embodiments, the cavity 58 may house or enclose the motor 38, a fan 74, and/or a drive assembly 78 that couples the motor 38 and the fan 74. The motor 38 may be positioned such that the majority of the motor 38 is disposed within the cavity 58. The motor 38 may be vertically aligned such that the motor 38 spins respective to a motor axis 80 being orthogonal to the lower side 62.

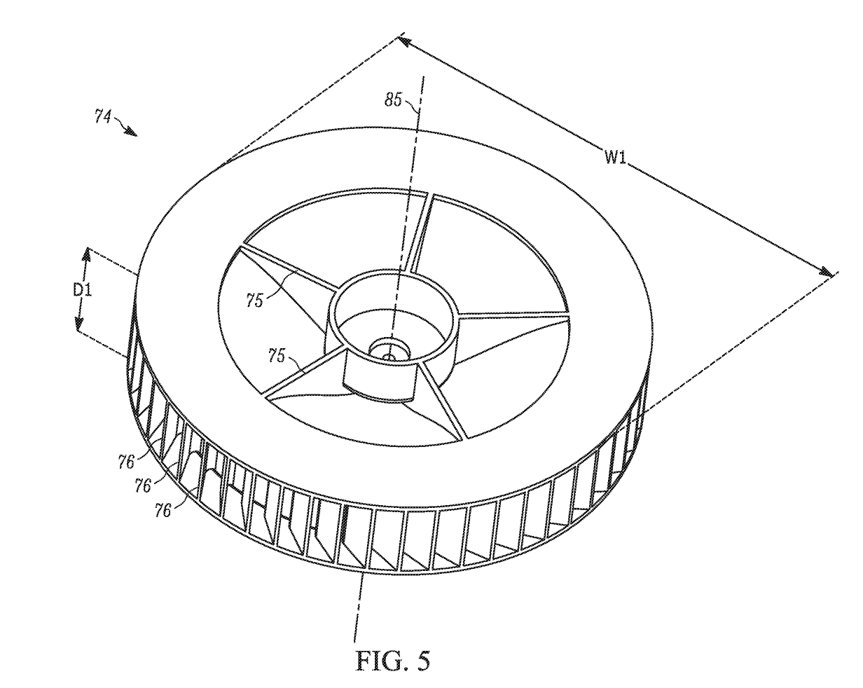

In some embodiments, the fan 74 may be spaced apart from the motor 38 within the cavity 58. In the illustrated embodiment, the fan 74 may be a centrifugal fan configured rotate respective to a fan axis 85. The fan axis 85 may be parallel to, but offset from the motor axis 80. As shown in FIG. 5, the fan 74 may include a plurality of central blades 75 and a plurality of peripheral blades 76. The fan axis 85 may be aligned with an aperture or intake hole 72, which may extend through the upper side 30 of the light and fan assembly 10. The outlets 50 may be radially disposed respective to the intake hole 72. The intake hole 72 may provide fluid communication between an external environment (e.g., air in a room containing the light and fan assembly 10) and the fan 74. The fan 74 may include a depth D₁ and a width W₁ (e.g., a circumference). In some embodiments, the fan 74 may include a pancake-type centrifugal fan, such that the width W₁ of the fan 74 (e.g., a dimension measured respective to an axis orthogonal to the fan axis 85) is greater than the depth D₁ (e.g., a dimension measured respective to an axis parallel to the fan axis 85). That is, the fan 74 may have a shallow depth compared to a width.

In some embodiments, the depth D₁ may be less than twenty-four inches. In other embodiments, the depth D₁ may be less than eighteen inches. In other embodiments, the depth D₁ may be between one inch and fourteen inches. In other embodiments, the depth D₁ may be between two inches and twelve inches. In other embodiments, the depth D₁ may be between three inches and ten inches.

In some embodiments, the width W₁ is one and a half times as large as the depth D1. In other embodiments, the width W₁ is two times as large as the depth D₁. In other embodiments, the width W₁ is three times as large as the depth D₁. In other embodiments, the width W₁ is four times as large as the depth D₁. In other embodiments, the width W₁ is five times as large as the depth D1.

The shallow depth D₁ of the fan 74 may allow the light and fan assembly 10 to occupy a smaller footprint on or over the ceiling 22 and a minimum depth of a room. In some embodiments, multiple fans 74 may be positioned within the cavity 58 and be coupled to the same motor 38 or to different motors. In other embodiments, other suitable types of fans may be used (e.g., axial fans, and/or the like).

As shown in FIG. 4, the drive assembly 78 may include a drive pulley 82, a driven pulley 84, and/or a belt 90. The drive pulley 82 may be coupled to a lower surface of the motor 38. In other words, the drive pulley 82 may be coupled to the motor 38 within the cavity 58, proximate the lower side 62. The drive pulley 82 may be configured to rotate about the motor axis 80. The driven pulley 84 may be coupled to a lower surface of the fan 74. In other words, the driven pulley 84 may be coupled to the fan 74 within the cavity 58, proximate the lower side 62. The driven pulley 84 may be configured to rotate about the fan axis 85. The drive pulley 82 and the driven pulley 84 may be centered on a plane parallel to the lower side 62. The belt 90 may extend between the drive pulley 82 and the driven pulley 84, such that the pulleys 82, 84 may be coupled together for co-rotational movement. In other embodiments, the drive assembly 78 may include other suitable components for transferring rotation from the motor 38 to the fan 74, such as a gear system or a direct drive system.

In some embodiments, the fan 74 may also be supported by a first bearing 94a and a second bearing 94b. The first bearing 94a may be coupled to the fan 74 proximate the upper side 30, and the second bearing 94b may be coupled to the fan 74 proximate the lower side 62. In the illustrated embodiment, the second bearing 94b may be positioned between the driven pulley 84 and the lower side 62. The bearings 94a, 94b may be configured to provide rotational support for the fan 74.

In some embodiments, the light and fan assembly 10 may include a wired electrical connection that draws electrical current from an outlet or power source (not shown). In other embodiments, the light and fan assembly 10 may include a connection terminal (not shown). The connection terminal may receive a battery (e.g., a rechargeable battery pack, not shown) which would provide electrical current to the light and fan assembly 10. The battery may be a power tool battery pack, and can be removed from the light and fan assembly 10 and coupled to a power tool (not shown) to provide the power tool with electrical current.

While the light and fan assembly 10 is in a first or off state, electrical current may not be supplied to the light emitter 26 and/or the motor 38. When a user switches the light and fan assembly 10 to a second or on state, electrical current may be supplied to the light emitter 26 and/or the motor 38. Other embodiments may include intermediate states where only the light emitter 26 receives electrical current, where only the motor 38 receives electrical current, and/or the like. In some embodiments, the light and fan assembly 10 may be controlled by a one or more actuators (e.g., buttons, dials, etc.) supported on the body 14 and/or by a wall switch remotely located from the light and fan assembly 10. Additionally, or alternatively, the light and fan assembly 10 may be controlled by a remote control or an app on a smartphone or computer.

In the on state, the light emitter 26 may emit light that passes through the lens 18 and into an external environment (e.g., a room). Alternatively, the light and fan assembly 10 may be devoid of a lens 18, in which case, light may be emitted directly into the external environment. Emitted light may extend away from the ceiling 22 in order to illuminate the external environment.

Additionally, the motor 38 may be powered in the on state. The motor 38 may rotate and cause the drive pulley 82 to rotate. The rotation of the drive pulley 82 may drive the belt 90. As the drive pulley 82 rotates, energy from the motor 38 may be transferred to the belt 90. The energy may allow the belt 90 to drive the driven pulley 84. Rotation of the driven pulley 84, in turn, may actuate the fan 74.

As the fan 74 rotates, air 98 (see e.g., FIG. 2) may be drawn into the light and fan assembly 10 from the external environment through the gap 56 (e.g., the inlet), and through the intake hole 72. The air 98 may enter the fan 74 from the intake hole 72 and contact the central blades 75, further actuating the fan 74. Rotation of the fan 74 may cause the peripheral blades 76 to exhaust air 102 (see, e.g., FIG. 3) out around a circumference of the fan 74 and out of the light and fan assembly 10 by way of outlets 50. The exhaust air 102 may travel through the cavity 58 to the exhaust walls 70. The exhaust air 102 may travel over and/or around the exhaust walls 70 and out of the light and fan assembly 10 through the outlets 50. The exhaust air 102 may provide cooling air to the external environment below the light and fan assembly 10, in some embodiments. The cooling air may also be configured to dissipate heat from the light emitter 26, thereby conserving energy and reducing waste.

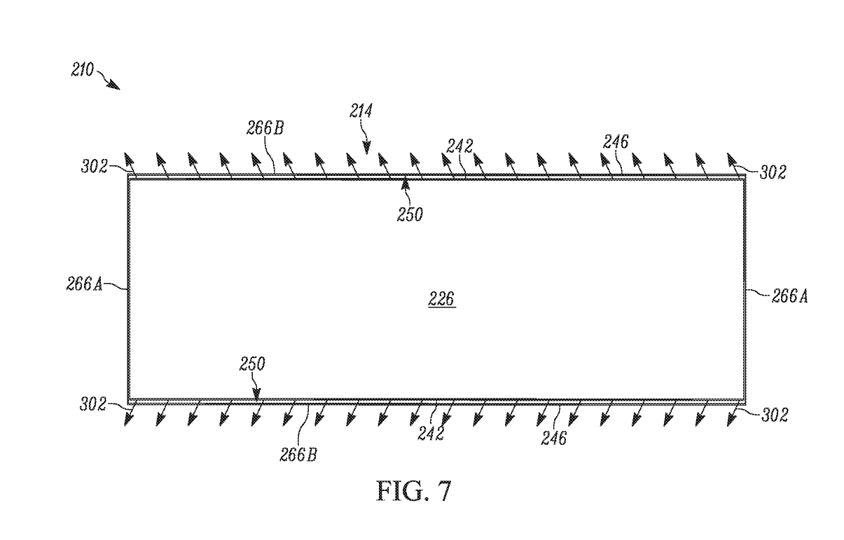

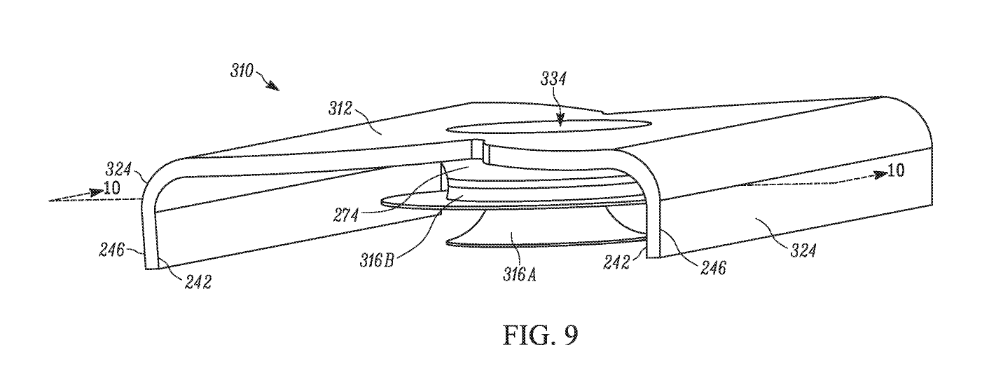

Referring now to FIG. 6, another embodiment of a light and fan assembly 210 is shown. In the illustrated embodiment, the light and fan assembly 210 may include a puff light that is configured to be mounted to a ceiling 22 (see e.g., FIG. 9). The light and fan assembly 210 may include a body 214 and a light unit 216 positioned proximate to (e.g., adjacent to, against, and/or the like) the body 214. The light unit 216 may include a lens 218 and a light emitter 226 (see e.g., FIG. 7). The body 214 may be formed from stamped sheet metal, molded plastic, and/or the like, and may be rectangular in some cases. In some embodiments, the body 214 may have rounded or chamfered corners. In other embodiments, the body 214 may have other desired shapes as noted above.

The illustrated body 214 may include a first, upper side 230, a second, lower side 262, third and fourth sides or respective end walls 266A, and fifth and sixth sides or respective side walls 266B. Each side wall 266B may be disposed between the end walls 266A. The end walls 266A and the side walls 266B may also be disposed between the upper and lower sides 230, 232. In the illustrated embodiment, the end walls 266A may include a plurality of openings (e.g., intake openings, inlets, and/or the like) formed as one or more grates 272 that define an inlet region. The inlet regions may be disposed in the third and fourth sides 266A of the body 214. The upper side 230 of the body 214 may or may not contact the ceiling 22 upon mounting the light and fan assembly 210. The light emitter 226 may be covered by the lens 218, and may be configured to illuminate an area beneath the ceiling 22. The lens 218 may include a lens similar to lens 18 described above, and may include a light diffusing lens, a light reflecting lens, a light guiding lens, and/or the like. The lens 218 may be optically transparent or partially non-transparent. Further, the lens 218 may comprise plastic having a smooth surface, a curved surface, a textured surface, a linear surface, a surface having any combination of the aforementioned aspects, and/or the like.

As shown in FIG. 7, the light emitter 226 may face away from the upper side 230 (see e.g., FIG. 9) of the body 214. The illustrated light emitter 226 may include an LED panel formed by a plurality of LEDs. In other embodiments, the light emitter 236 may include other suitable lighting elements (e.g., fluorescent or incandescent bulbs). The light emitter 226 may extend along the lower side 262 of body 214 between the end walls 266A. Portions of an outer perimeter of the light emitter 226 that are proximate the side walls 266B may be spaced apart from the side walls 266B to define outlets 250 therebetween. A first outlet 250 may be define between a first side wall 266B and the light emitter 226, and a second outlet 250 may be defined between a second side wall 266B and the light emitter 226. The outlets 250 may extend along opposing edges of the light emitter 226 adjacent the side walls 266B. In the illustrated embodiment, the outlets 250 may extend continuously (i.e., uninterrupted) between the end walls 266A. In other embodiments, the outlets 250 may be subdivided into a plurality of outlets or may extend a length less than an entire length between the end walls 266A.

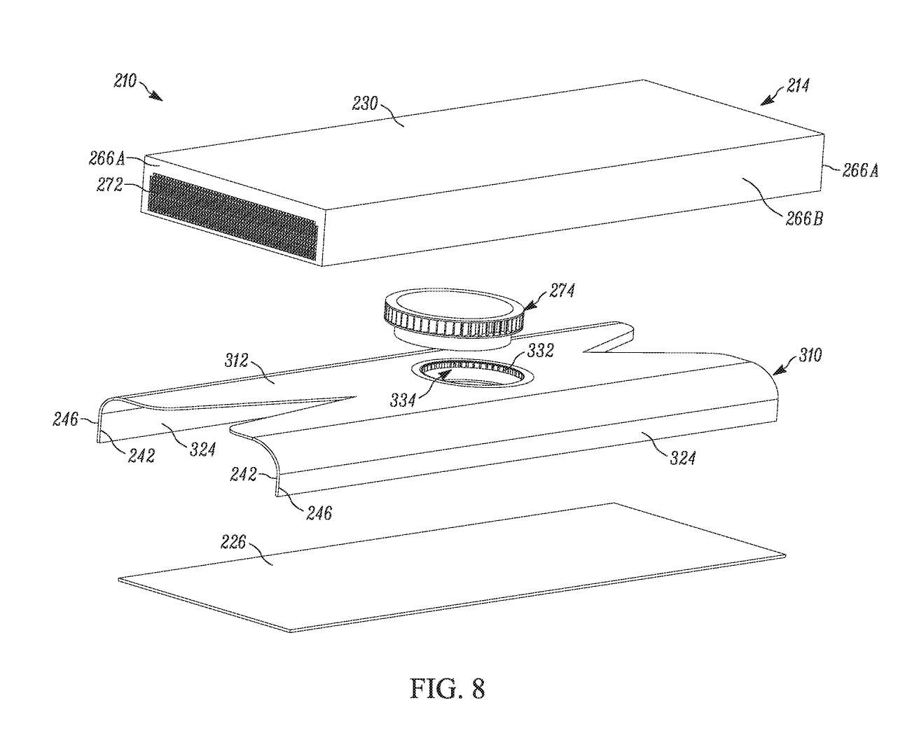

As shown in FIGS. 8-12, the light and fan assembly 210 may include an internal cavity 258 disposed and/or defined by or between the upper side 230, the lower side 262, and respective end and side walls 266A, 266B. An inner, air directing member, such as an inner housing 310, a fan 274, and/or a motor 238 of the light and fan assembly 210 may be disposed in the cavity 258.

In some embodiments, the inner housing 310 may extend longitudinally between the end walls 266A and between the side walls 266B. The inner housing 310 may include an upper surface 312 formed by two semi-elliptically shaped portions disposed back-to-back (e.g., a curved side of one semi-ellipse portion intersects with a curved sided of the other semi-ellipse portion).

With reference to FIGS. 9-11, the inner housing 310 may include a central body 314 disposed proximate the intersection of the semi-elliptically shaped portions. The central body 314 may define an inner flow chamber including an inner ring 316A and an outer flow chamber including outer ring 316B spaced apart from the inner ring 316A. An air passage or airflow cavity 320 may be disposed between the respective inner and outer rings 316A, 316B. A pair of arms 324 may extend away from the body 314. Each arm 324 may define an inner periphery 242 of the housing 310 and an outer periphery 246 spaced from the inner periphery 242. Together, each pair of inner and outer peripheries 242, 246 may define a channel 328, which may be in fluid communication with the cavity 320. Each channel 328 may initiate proximate an intake 330 (e.g., formed by inlets or grates 272) disposed between the rings 316A, 316B, and terminate proximate the one or more outlets 250 positioned proximate the lower side 262 of the light and fan assembly 210. One or more stationary blades or stator vanes 332 may be disposed in the channel 328 proximate the cavity 320 for redirecting the airflow radially out from an impeller (not shown) of a fan 274. In the illustrated embodiment, the stator vanes 332 may be evenly spaced (e.g., at even increments) around a circumference of the outer ring 316B or unevenly spaced (e.g., at uneven increments) around the circumference of the outer ring 316B.

In the illustrated embodiment, the inner housing 310 may be symmetrical about an axis 285 that extends through a center of the central body 314 (e.g., each semi-ellipse may have substantially the same area and perimeter). Each arm 324 may extend from an upper surface 312 of the housing 310 (e.g., proximate the upper side 230 with the housing 310 disposed within the body 214), and may curve away from the upper surface 312 (e.g., down to the lower side 262 of the light and fan assembly 210 adjacent to the side walls 266B). The channels 328 may extend the length of both side walls 266B. Each channel 328 may also be in fluid communication with one or more of the outlets 250 to direct air out of the light and fan assembly 210.

In some embodiments, the fan 274 may be coupled to the housing 310 and be disposed within a central opening 334 of the housing 310. The fan 274 may be aligned with the inner ring 316A and the outer ring 316B between the housing 310 and the upper side 230. Both the housing 310 and the fan 274 may have a hollow center (e.g., along axis the axis 285) and together may define a chamber 336 that may be configured to house the motor 238. In the illustrated embodiment, the chamber 336 may be bell shaped, and may be in communication with the central opening 334. The motor 238 and the fan 274 may be configured to rotate about the axis 285 (e.g., the axis 285 may represent both a fan axis and a motor axis so that the fan and motor axes are collinear).

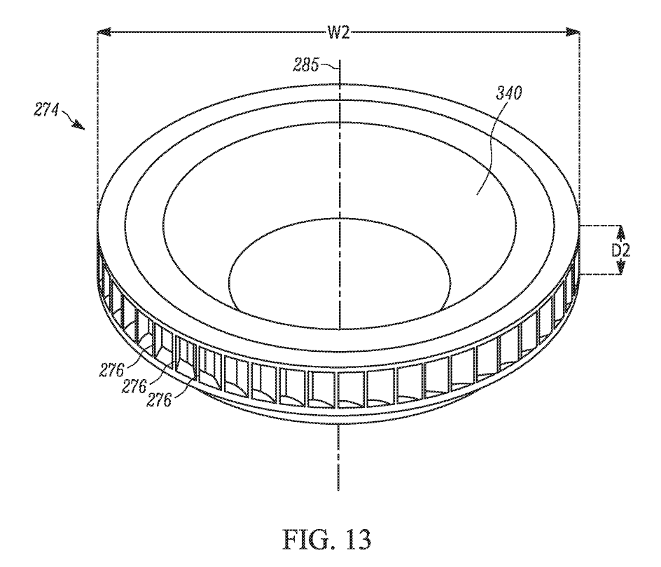

With reference to FIG. 13, the fan 274 may be a centrifugal fan. Other types of fans are contemplated. The fan 274 may include a smooth center 340 and peripheral blades 276. The fan 274 may include a pancake-type centrifugal fan such that a width W₂ of the fan 274 (e.g., a dimension measured about an axis orthogonal to the axis 285) may be greater than a depth D₂ (e.g., a dimension measured about an axis measured parallel to the axis 285).

In some embodiments, the depth D₂ may be less than twenty-four inches. In other embodiments, the depth D₂ may be less than eighteen inches. In other embodiments, the depth D₂ may be between one inch and fourteen inches. In other embodiments, the depth D₂ may be between two inches and twelve inches. In other embodiments, the depth D₂ may be between three inches and ten inches.

In some embodiments, the width W₂ is one and a half times as large as the depth D₂. In other embodiments, the width W₂ is two times as large as the depth D₂. In other embodiments, the width W₂ is three times as large as the depth D₂. In other embodiments, the width W₂ is four times as large as the depth D₂. In other embodiments, the width W is five times as large as the depth D₂.

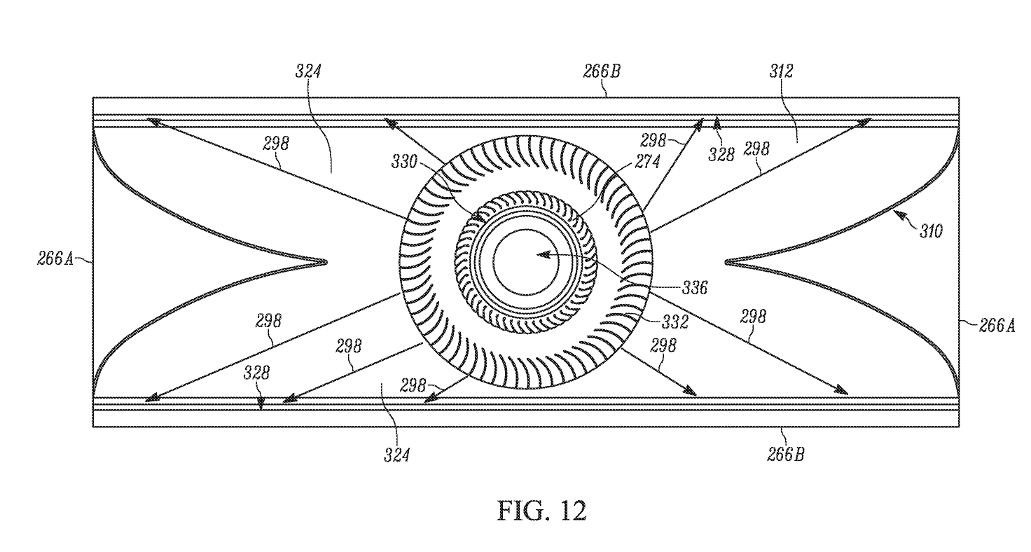

In use, electrical power may be supplied to the motor 238 (e.g., by a battery, a wired connection, and/or the like), which causes the motor 238 to rotate. The motor 238 may transfer energy to the fan 274. As shown in FIG. 9, rotation of the fan 274 may cause air 298 to be drawn into the light and fan assembly 10 from the external environment. For example, the air 298 may be drawn into the light and fan assembly 10 through the inlets (e.g., grates 272) of the end walls 266A, and into the cavity 320. The air 298 may enter the centrifugal fan 274 through the intakes 330 in a direction generally toward the ceiling 22. A diameter of each intake 330 may be sufficiently wide so as to reduce restricting flow of the air 298 through the light and fan assembly 10. Rotation of the fan 274 may cause the peripheral blades 276 to exhaust the air 298 along a path 302 in all directions around a circumference of the fan 274 and through the stator vanes 332. The stator vanes 332 may redirect the air 298 radially out from the fan 274, and may cause the air 298 to experience substantially laminar flow along the path 302. As seen in FIG. 12, the air 298 may disperse around the semi-elliptical shape of the inner housing 310. In some embodiments, the air 298 may be dispersed equally from the stator vanes 332 and around the inner housing 310. In this way, a substantially equivalent amount of air 298 may travel along the path 302 and into each arm 324. The air 298 may travel along the arms 324 and through the channels 328, to exit through the outlets 250. The channels 328 may be wider proximate the stator vanes 332 (i.e., proximate the upper surface 312) than proximate the exhaust slots 250, in some embodiments. Tapering the channels 328 in this way may reduce overexpansion of the air being exhausted from the light and fan assembly 210. The air 298 being exhausted from the light and fan assembly 210 may be directed away from (e.g., downwardly) from the ceiling 22 towards a surface or object in a room facing the ceiling 22, and may provide circulate air in the external environment around and/or below the light and fan assembly 210. In the illustrated embodiment, the fan 274 may be inverted (i.e., positioned upside down). The positioning of the fan 274, along with the stator vanes 332, may increase the uniformity of the airflow through the channels 328, and may decrease the sound output by the fan 274.

The embodiment(s) described above and illustrated in the figures are presented by way of example only and are not intended as a limitation of the present subject matter. As such, it will be appreciated that variations and modifications to the elements and their configuration and/or arrangement may exist.

Various features of the present subject matter are set forth in the following claims.

What is claimed is:

1. A light and fan assembly comprising:
a body including:
a first side configured to be positioned adjacent to a ceiling,
a second side opposite the first side, and
an internal cavity disposed between the first side and the second side;
a light unit disposed on the second side of the body,
the light unit having an outer perimeter, and
at least a portion of the outer perimeter being spaced apart from the body to define an outlet therebetween;
a motor positioned within the internal cavity; and
a fan positioned within the internal cavity and coupled to the motor,
the fan being operable to draw air into the internal cavity and exhaust the air out of the body through the outlet.

2. The light and fan assembly of claim 1 further comprising a first inlet in fluid communication with the internal cavity.

3. The light and fan assembly of claim 2, wherein the first inlet comprises a plurality of openings formed in a first portion of the body.

4. The light and fan assembly of claim 2, wherein the fan is disposed between the first inlet and a second inlet formed in a second portion of the body, the second portion of the body being opposite the first portion of the body.

5. The light and fan assembly of claim 1, wherein the outlet extends continuously around a perimeter of the body.

6. The light and fan assembly of claim 1, further comprising an inner housing positioned within the internal cavity, wherein the inner housing includes a central opening, and wherein the fan is positioned within the central opening.

7. The light and fan assembly of claim 6, wherein the inner housing is configured to direct the air through an internally disposed channel in fluid communication with the outlet.

8. The light and fan assembly of claim 6, wherein stationary vanes are formed in the inner housing.

9. The light and fan assembly of claim 8, wherein the stationary vanes are disposed around the central opening.

10. The light and fan assembly of claim 1, wherein the fan rotates about a fan axis and the motor rotates about a motor axis, and wherein the motor axis and the fan axis are collinear.

11. The light and fan assembly of claim 1, wherein the light unit includes one or more light emitting diodes (LEDs).

12. The light and fan assembly of claim 1, further comprising spacers coupled to the first side of the body and configured to mount to the ceiling, the spacers forming a gap between the first side of the body and the ceiling for allowing the air to enter the internal cavity.

13. The light and fan assembly of claim 1, wherein the fan is a centrifugal fan.

14. The light and fan assembly of claim 1, wherein the fan has an overall depth and an overall width, and wherein the overall width is greater than the depth.

15. A light and fan assembly comprising:
a body including:
a first side configured to be positioned adjacent to a ceiling,
a second side opposite the first side, the second side defining an outlet,
a third side disposed between the first and second sides,
the third side defining a first inlet,
a fourth side opposite the third side,
the fourth side defining a second inlet, and
an internal cavity disposed between the first, second, third, and fourth sides,
the internal cavity being in fluid communication with the first inlet, the second inlet, and the outlet;
a light unit disposed on the second side of the body;
an inner housing positioned within the internal cavity,
the inner housing defining a central opening;
a motor positioned within the internal cavity; and
a fan positioned within the central opening of the inner housing and coupled to the motor,
the fan operable to draw air into the internal cavity through the first inlet and the second inlet and propel the air out of the body through the outlet.

16. The light and fan assembly of claim 15, wherein the inner housing includes:
a first arm extending from the central opening to the first outlet,
the first arm defining a first channel in fluid communication with a first outlet, and
a second arm extending from the central opening to the second outlet,
the second arm defining a second channel in fluid communication with a second outlet.

17. The light and fan assembly of claim 16, wherein the first outlet extends continuously along a fifth side of the body between the third side and the fourth side, and wherein the second outlet extends continuously along a sixth side of the body between the third side and the fourth side.

18. The light and fan assembly of claim 15, wherein a plurality of stationary vanes are formed about the central opening.

19. The light and fan assembly of claim 15, wherein the light unit includes one or more light emitting diodes (LEDs).

20. The light and fan assembly of claim 15, wherein the fan rotates about a fan axis and the motor rotates about a motor axis, and wherein the motor axis and the fan axis are collinear.
